(19) United States
(12) Patent Application Publication
(10) Pub. No.: US 2026/0114679 A1
(43) Pub. Date: Apr. 30, 2026

(54) Multi-Arm Hygienic Drying Device

(71) Applicant: Natalie Calder, Pen Argyl, PA (US)

(72) Inventor: Natalie Calder, Pen Argyl, PA (US)

(21) Appl. No.: 19/339,459

(22) Filed: Sep. 25, 2025

Related U.S. Application Data
(60) Provisional application No. 63/714,234, filed on Oct. 31, 2024.

(51) Int. Cl. A47K 10/14; F16M 11/14; F16M 11/20; F16M 13/02

(52) U.S. Cl. CPC A47K 10/14; F16M 11/14; F16M 11/2021; F16M 13/022

(57) ABSTRACT

A multi-arm hygienic drying device is provided. The device is comprised of a drying device configured for the sanitary, efficient, and spatially optimized drying of washcloths and other fabric articles in moisture-prone environments such as bathrooms. The device comprises at least one fastener end designed to secure the assembly to fixed structures such as shower rods, tiles, or bathroom walls, using clips, suction cups, adhesives, or magnetic mounts. A primary support arm may be pivotably attached to the fastener end. At the distal end of the primary support arm is a central hub from which multiple secondary arms extend. Each secondary arm is independently positionable via ball-and-socket or equivalent joints, with associated locking mechanisms to maintain the desired orientation. The terminal ends of the secondary arms are equipped with gripping mechanisms designed to hold individual fabric items while drying.

### CROSS-REFERENCE TO RELATED APPLICATION

The present application claims priority to, and the benefit of, U.S. Provisional Application No. 63/714,234, which was filed on Oct. 31, 2024, and is incorporated herein by reference in its entirety.

### FIELD OF THE INVENTION

The present invention relates generally to the field of drying devices. More specifically, the present invention relates to a drying device configured for sanitary, efficient, and space-optimized drying of washcloths and similar fabric articles in moisture-prone environments. Accordingly, the present disclosure makes specific reference thereto. Nonetheless, it is to be appreciated that aspects of the present invention are also equally applicable to other like applications, devices, and methods of manufacture.

### BACKGROUND

In residential and commercial bathroom environments, the persistent issue of damp fabric items such as washcloths, towels, and similar articles contributes to the growth of mold, mildew, and bacterial colonies. These microorganisms thrive in warm, humid conditions, which are commonly present in enclosed bathroom spaces following bathing or showering. Users often attempt to air-dry washcloths by placing them over shower rods, faucets, or towel racks. However, these locations frequently lack sufficient airflow or spatial separation to allow uniform and rapid evaporation of moisture across the entire fabric surface. Incomplete drying results in residual dampness, promoting microbial growth and generating unpleasant odors. Over time, repeated improper drying can also lead to the stiffening, discoloration, and degradation of fabric integrity. Additionally, bathrooms typically have limited fixture space, making the use of existing surfaces for fabric drying inefficient and cluttered.

Therefore, there exists a long-felt need in the art for a multi-arm hygienic drying device that allows individual fabric items to dry efficiently with maximum air exposure. There also exists a long-felt need in the art for a multi-arm hygienic drying device that prevents microbial growth by minimizing moisture retention. Moreover, there exists a long-felt need in the art for a multi-arm hygienic drying device that frees up space in bathrooms by providing a dedicated drying structure.

The subject matter disclosed and claimed herein, in one embodiment thereof, comprises a multi-arm hygienic drying device. The device is comprised of a drying device configured for the sanitary, efficient, and spatially optimized drying of washcloths and other fabric articles in moisture-prone environments such as bathrooms. The device comprises at least one fastener end designed to secure the assembly to fixed structures such as shower rods, tiles, or bathroom walls, using clips, suction cups, adhesives, or magnetic mounts. A primary support arm may be pivotably attached to the fastener end. At the distal end of the primary support arm is a central hub from which multiple secondary arms extend. Each secondary arm is independently positionable via ball-and-socket or equivalent joints, with associated locking mechanisms to maintain the desired orientation. The terminal ends of the secondary arms are equipped with gripping mechanisms designed to hold individual fabric items while drying.

In this manner, the multi-arm hygienic drying device of the present invention accomplishes all the forgoing objectives and provides a device that promotes uniform air circulation and reduces moisture retention in fabric items being dried in a suspended manner. The articulated structure further ensures each fabric article remains separated and optimally oriented for drying, directly addressing the challenge of microbial growth associated with damp materials. Additionally, by attaching to existing bathroom surfaces and incorporating multi-arm expansion, the device optimizes vertical and lateral space, thus resolving the issue of bathroom clutter and inefficiency commonly caused by drying fabrics on standard fixtures.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multi-arm hygienic drying device. The device is configured to support hygienic, efficient, and organized drying of washcloths and small fabric articles in wet environments. The device enables individual suspension of fabric items using articulated arms and gripping mechanisms, promoting airflow exposure, reducing moisture retention, and preventing mold or bacteria growth. This configuration eliminates the need to use existing bathroom fixtures and improves drying speed and sanitation by maintaining proper separation and ventilation around fabric items.

The device is comprised of at least one fastener end configured to secure the device to a fixed surface or structure. In one embodiment, the fastener end includes a clip-like structure designed to attach to horizontal supports such as shower rods or towel bars. In another embodiment, the fastener end is comprised of suction fastening elements.

The device is further comprised of at least one primary support arm pivotably attached to the fastener end via a pivot point. The pivot point permits rotational movement across one or more axes and may have a locking mechanism to restrict or fix the angular position of the primary support arm. In one embodiment, the primary support arm includes multiple articulation points enabling independent movement of individual segments.

The distal end of the primary support arm terminates in a central hub configured to rotate about a vertical or horizontal axis. A plurality of secondary arms are attached to the central hub via connection points which enables independent multi-directional positioning of the corresponding secondary arm. Each secondary arm is comprised of a fastener end that includes at least one gripping mechanism designed to secure hanging items. In one embodiment, the fastener end includes a primary locking mechanism to maintain closure of the gripping mechanism. In another embodiment, the fastener end is mounted on a secondary pivot point allowing independent rotation or tilt.

Accordingly, the multi-arm hygienic drying device of the present invention is particularly advantageous as it provides a device that promotes uniform air circulation and reduces moisture retention in fabric items being dried in a suspended manner. The articulated structure further ensures each fabric article remains separated and optimally oriented for drying, directly addressing the challenge of microbial growth associated with damp materials. Additionally, by attaching to existing bathroom surfaces and incorporating multi-arm expansion, the device optimizes vertical and lateral space, thus resolving the issue of bathroom clutter and inefficiency commonly caused by drying fabrics on standard fixtures.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a multi-arm hygienic drying device of the present invention in accordance with the disclosed architecture;

FIG. 2 illustrates a perspective view of one potential embodiment of a multi-arm hygienic drying device of the present invention in accordance with the disclosed architecture; and

FIG. 3 illustrates a perspective view of one potential embodiment of a multi-arm hygienic drying device of the present invention while drying items in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a multi-arm hygienic drying device that allows individual fabric items to dry efficiently with maximum air exposure. There also exists a long-felt need in the art for a multi-arm hygienic drying device that prevents microbial growth by minimizing moisture retention. Moreover, there exists a long-felt need in the art for a multi-arm hygienic drying device that frees up space in bathrooms by providing a dedicated drying structure.

The present invention, in one exemplary embodiment, is comprised of a multi-arm hygienic drying device. The device is designed to facilitate efficient and organized drying of washcloths and small fabric articles within wet environments. By suspending individual fabric items using articulated arms and gripping mechanisms, the device enhances exposure to ambient airflow, minimizes moisture retention, and inhibits mold and bacterial growth. This configuration removes reliance on traditional bathroom fixtures and improves both drying speed and sanitation through consistent separation and ventilation of fabric items.

The device comprises at least one fastener end that secures the structure to a fixed surface. In one embodiment, the fastener end features a clip-like structure intended for attachment to horizontal supports such as towel bars or shower rods. In another embodiment, suction fastening elements are employed to provide secure attachment.

At least one primary support arm is pivotably connected to the fastener end via a pivot point, which permits rotation across one or more axes. A locking mechanism may be included to limit or fix the angular position of the primary support arm. In one embodiment, the primary support arm includes multiple articulation points, allowing independent movement of each segment.

A central hub is positioned at the distal end of the primary support arm and is configured to rotate about a vertical or horizontal axis. A plurality of secondary arms extend from the central hub, each connected via articulation points that allow for independent multi-directional positioning. Each secondary arm terminates in a fastener end comprising at least one gripping mechanism for securing hanging items. In one embodiment, the fastener end includes a primary locking mechanism to maintain closure of the gripping mechanism. In another embodiment, the fastener end is mounted on a secondary pivot point, allowing for independent tilting or rotation.

As a result, the device provides significant advantages by promoting uniform air circulation and reducing moisture retention in suspended fabric items. The articulated structure ensures optimal orientation and separation of each item, effectively mitigating microbial growth in damp environments. Furthermore, the device maximizes use of vertical and lateral space by attaching to existing bathroom surfaces and deploying a multi-arm design, thereby reducing clutter and improving spatial efficiency.

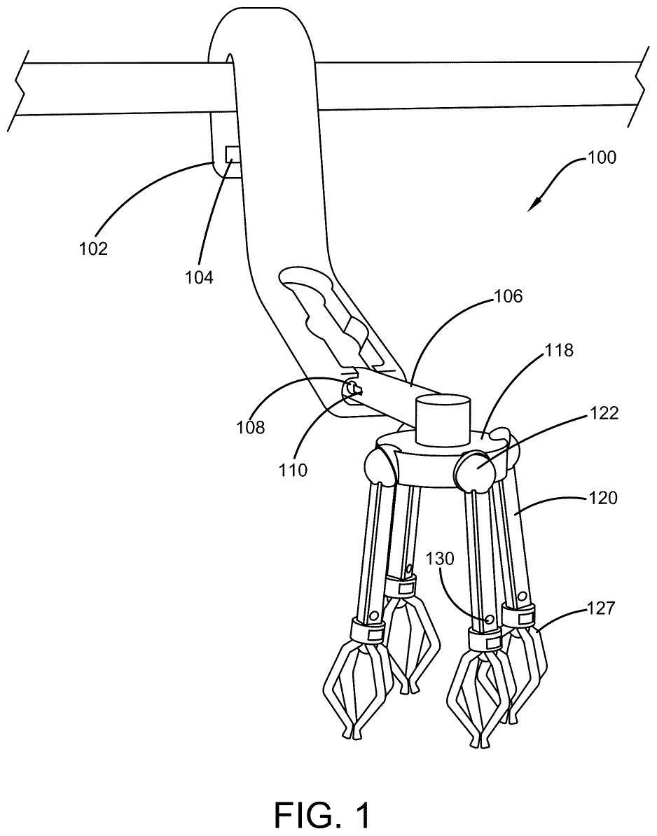

Referring initially to the drawings, FIG. 1 illustrates a perspective view of one potential embodiment of a multi-arm hygienic drying device 100 of the present invention in accordance with the disclosed architecture. The device 100 is configured to support the hygienic, efficient, and organized drying of washcloths and other small fabric articles in a bathroom or other wet environment. The device 100 may be designed to suspend individual fabric items using a series of articulated arms and gripping mechanisms, enabling full exposure to ambient airflow. This configuration may assist in reducing moisture retention, preventing the growth of mold, mildew, and bacteria, and freeing space on existing bathroom fixtures such as but not limited to shower rods, towel racks, and countertops. The device 100 may further facilitate proper separation and ventilation around individual fabric items, thereby enhancing drying speed and promoting sanitary conditions.

The device 100 is comprised of at least one fastener end 102 configured to secure the device 100 to a fixed structure or surface. In one embodiment, the fastener end 102 may be comprised of a clip structure, a hook structure, or a curved structure configured to engage with cylindrical or polygonal horizontal supports such as but not limited to a standard shower curtain rod, tension rod, or towel bar, as seen in FIG. 1. The clip-like structure may be comprised of additional securing elements 104 such as but not limited to any combination of hinged jaws, spring-tensioned clamps, over-center latches, rubberized grips, or articulated brackets.

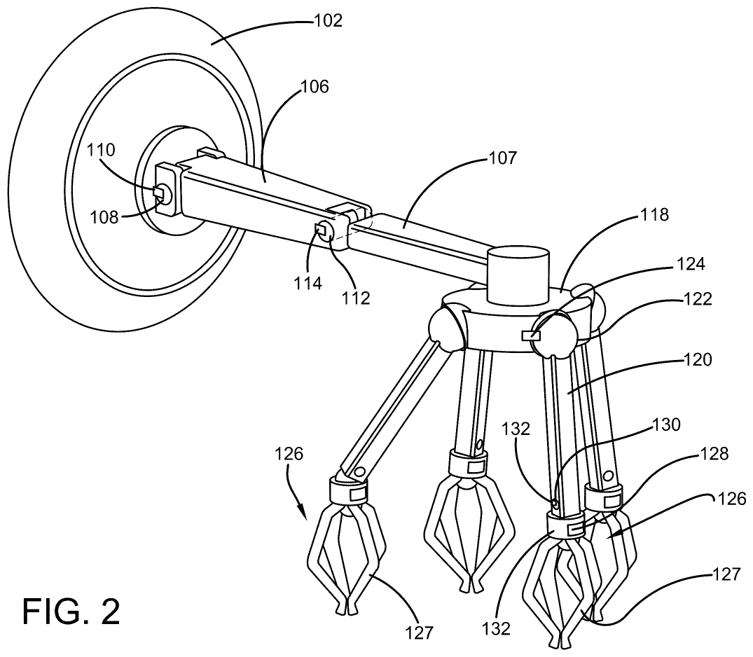

In another embodiment, the fastener end 102 may be comprised of a suction fastener such as but not limited to any combination of manual suction cups, vacuum-assisted suction cups, lever-actuated suction seals, or gel-based adhesive pads, as seen in FIG. 2. These suction fastening elements may be configured to engage with smooth surfaces such as but not limited to glass, glazed tile, fiberglass, acrylic panels, or polished metal. In yet another embodiment, the fastener end 102 may be comprised of adhesive backing, magnetic fasteners, or threaded openings suitable for installation onto walls, ceilings, or shower enclosures.

The device 100 is further comprised of at least one primary support arm 106. The primary support arm 106 may be pivotably attached to the fastener end 102 via a pivot point 108. The pivot point 108 may be configured to enable rotational movement across one or more axes and may be comprised of mechanical hinges, ball joints, friction-fit couplings, swivel brackets, or torsion-flex joints. The pivot point 108 may be operatively coupled to a locking mechanism 110 configured to restrict or fix the angular position of the primary support arm 106. The locking mechanism 110 may be comprised of elements such as but not limited to any combination of threaded knobs, cam levers, spring detents, ratchet rings, magnetic latches, or dual-axis clamps.

In one embodiment, the primary support arm 106 may be comprised of a multi-articulation point arm comprised of a plurality of sequential articulation points 112, as seen in FIG. 2. Each articulation point 112 may enable independent movement of associated segments 107 of the primary support arm 106. Each articulation point 112 may be comprised of joint types such as but not limited to rotating hinges, pivot blocks, universal joints, segmented sleeves, telescoping linkages, or flexible ball-link assemblies. Each articulation point 112 may be coupled to an individual locking mechanism 114 configured to secure the articulation in either a fixed or adjustable state. The locking mechanism 114 may be comprised of but not limited to any combination of pressure collars, threaded locking sleeves, press-to-release cams, rotational stops, or twist-lock elements.

The distal end of the primary support arm 106 may terminate in a central hub 118. The central hub 118 may be configured to rotate about a central vertical or horizontal axis in one embodiment. Attached to the central hub 118 may be a plurality of secondary arms 120. Each secondary arm 120 may be connected to the central hub 118 via at least one connection point 122 such as but not limited to any combination of a ball and socket joint or equivalent multi-axis articulation point. Each connection point 122 may be configured to enable the corresponding secondary arm 120 to be positioned independently in multiple directions. The connection point 122 may include integrated or separate locking mechanisms 124 comprised of adjustable torque collars, compression rings, or pin-and-hole locking disks.

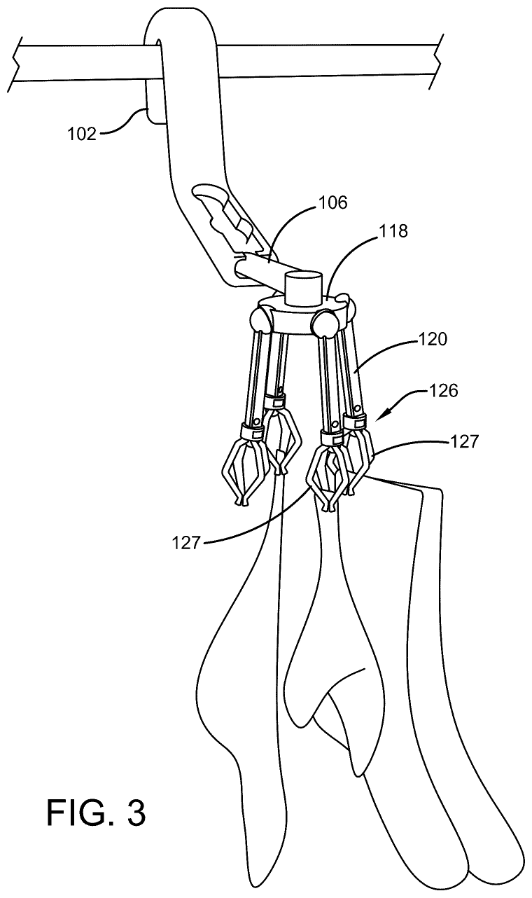

Each secondary arm 120 may be comprised of a fastener end 126. The fastener end 126 may be comprised of at least one gripping mechanism 127 configured to secure washcloths, sponges, or other hanging items to the device 100, as seen in FIG. 3. The gripping mechanism 127 may be comprised of any combination of spring-loaded clamps, alligator clips, magnetic clasps, pivoting jaws, hook-and-loop patches, elastic tension bands, or molded friction grooves.

In one embodiment, the fastener end 126 may include a primary locking mechanism 128 configured to maintain closure of the gripping mechanism 127, as seen in FIG. 2. The locking mechanism 128 may be comprised of but is not limited to any combination of lever-locks, push-button catches, over-center linkages, slide locks, or rotational cams. In another embodiment, the fastener end 126 may be mounted on a secondary pivot point 130. The secondary pivot point 130 may be configured to allow the fastener end 126 to rotate or tilt independently of the secondary arm 120 and may be comprised of joint structures similar to those previously described. The secondary pivot point 130 may further include a secondary locking mechanism 132 comprised of but not limited to any combination of detent grooves, threaded collars, torque-adjustable bushings, or stop rings.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “multi-arm hygienic drying device” and “device” are interchangeable and refer to the multi-arm hygienic drying device 100 of the present invention.

Notwithstanding the foregoing, the multi-arm hygienic drying device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the multi-arm hygienic drying device 100 as shown in the FIGS. are for illustrative purposes only, and that many other sizes and shapes of the multi-arm hygienic drying device 100 are well within the scope of the present disclosure. Although the dimensions of the multi-arm hygienic drying device 100 are important design parameters for user convenience, the multi-arm hygienic drying device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multi-arm hygienic drying device comprising:
a first fastener end;
a primary support arm pivotably attached to the fastener end via a first pivot point;
a central hub connected to the primary support arm; and
a secondary arm attached to the central hub via a connection point, the secondary arm comprised of a second fastener end comprised of a gripping mechanism.

2. The multi-arm hygienic drying device of claim 1, wherein the first fastener end is comprised of a clip, a curved structure, or a hook.

3. The multi-arm hygienic drying device of claim 1, wherein the first fastener end is comprised of a suction fastener.

4. The multi-arm hygienic drying device of claim 3, wherein the suction fastener is comprised of a manual suction cup, a vacuum-assisted suction cup, a lever-actuated suction seal, or a gel-based adhesive pad.

5. The multi-arm hygienic drying device of claim 1, wherein the first fastener end is comprised of an adhesive backing or a magnetic fastener.

6. The multi-arm hygienic drying device of claim 1, wherein the gripping mechanism is comprised of a spring-loaded clamp, an alligator clip, a magnetic clasp, a pivoting jaw, a hook-and-loop patch, an elastic tension band, or a molded friction groove.

7. The multi-arm hygienic drying device of claim 1, wherein the first fastener end is comprised of a securing element comprised of a hinged jaw, a spring-tensioned clamp, an over-center latch, a rubberized grip, or an articulated bracket.

8. A multi-arm hygienic drying device comprising:
a first fastener end;
a primary support arm pivotably attached to the fastener end via a first pivot point, wherein the primary support arm is comprised of an articulation point;
a central hub connected to the primary support arm; and
a secondary arm attached to the central hub via a connection point, the secondary arm comprised of a second fastener end comprised of a gripping mechanism.

9. The multi-arm hygienic drying device of claim 8, wherein the gripping mechanism is comprised of a spring-loaded clamp, an alligator clip, a magnetic clasp, a pivoting jaw, a hook-and-loop patch, an elastic tension band, or a molded friction groove.

10. The multi-arm hygienic drying device of claim 8, wherein the connection point is comprised of a ball and socket joint.

11. The multi-arm hygienic drying device of claim 8, wherein the primary support arm is comprised of a first locking mechanism.

12. The multi-arm hygienic drying device of claim 11, wherein the connection point is comprised of a second locking mechanism.

13. The multi-arm hygienic drying device of claim 8, wherein the second fastener end is comprised of a primary locking mechanism.

14. A multi-arm hygienic drying device comprising:
a first fastener end;
a primary support arm pivotably attached to the fastener end via a first pivot point;
a central hub connected to the primary support arm; and
a secondary arm attached to the central hub via a connection point, the secondary arm comprised of a locking mechanism and a second fastener end comprised of a gripping mechanism.

15. The multi-arm hygienic drying device of claim 14, wherein the gripping mechanism is comprised of a spring-loaded clamp, an alligator clip, a magnetic clasp, a pivoting jaw, a hook-and-loop patch, an elastic tension band, or a molded friction groove.

16. The multi-arm hygienic drying device of claim 14, wherein the primary support arm is comprised of a first locking mechanism.

17. The multi-arm hygienic drying device of claim 16, wherein the connection point is comprised of a second locking mechanism.

18. The multi-arm hygienic drying device of claim 17, wherein the second fastener end is comprised of a primary locking mechanism.

19. The multi-arm hygienic drying device of claim 14, wherein the connection point is comprised of a ball and socket joint.

20. The multi-arm hygienic drying device of claim 14, wherein the primary support arm is comprised of an articulation point.
